(19) United States
(12) Patent Application Publication
(10) Pub. No.: US 2010/0279162 A1
(43) Pub. Date: Nov. 4, 2010

(54) ELECTRIC ENERGY STORAGE DEVICE AND METHOD OF MANUFACTURING THE SAME

(76) Inventor: Kyung Sang Chun, Incheon (KR)

Correspondence Address: Jae Y. Park, Kile, Park, Reed & McManus, PLLC, 1200 New Hampshire Ave. NW, Suite 570, Washington, DC, 20036, US

(21) Appl. No.: 12/811,799

(22) PCT Filed: Jan. 17, 2008
(86) PCT No.: PCT/KR08/00284

§ 371 Date: Jul. 6, 2010

(51) Int. Cl. H01M 6/10; H01G 9/06

(52) U.S. Cl. 429/94; 361/513

(57) ABSTRACT

Provided is an electric energy storage device including: a terminal block for external connection (300) connected to an external electrode connection member such as an external resistor; a cylindrical can (200) for accommodating an electrode winding body (100); an electrolyte (61) impregnated in the electrode winding body (100); and an anti-vibration member (345) fixed to an outer periphery of a first projection of the terminal block (300) and resiliently pressed against an inner surface of one end of a winding core (12) inserted into a hollow part of the electrode winding body (100) to prevent movement of the electrode winding body (100) with respect to the terminal block (300). Therefore, the anti-vibration member is fixed to the first projection of the terminal block inserted into the winding core on which the electrode winding body is wound to make it possible to prevent generation of a gap between the electrode winding body and the terminal block due to external vibrations and increase in an internal pressure generated when the energy storage device is driven.

### BACKGROUND OF THE INVENTION

1. Field of the Invention

The present invention relates to an electric energy storage device and a method of manufacturing the same, and more particularly, to a cylindrical electric energy storage device and a method of manufacturing the same capable of suppressing a relative movement between an upper plate and a winding body, and reducing an electrolyte injection time.

2. Description of the Prior Art

In comparison with a primary battery having a discharge function only, a secondary battery such as a capacitor having charge and discharge functions employs various connection methods of terminals for electrically connecting an internal current source to an external resistor. As a result, such connection methods largely affect not only resistance and efficiency of the secondary battery, but also productivity of the secondary battery itself and use convenience thereof. Therefore, there is a strong need for a terminal connection method capable of increasing electric capacity and reducing internal resistance and functioning as a secondary battery, and an electric energy storage device using the same.

FIG. 1 is a perspective view of a conventional cylindrical electric energy storage device, FIG. 2 is a plan view of the cylindrical electric energy storage device shown in FIG. 1, FIG. 3 is a cross-sectional view taken along the line I-I′ of the cylindrical electric energy storage device shown in FIG. 1, and FIG. 5 is a plan view of an electrode winding body included in the conventional cylindrical electric energy storage device shown in FIG. 1.

Referring to FIGS. 1 to 3 and 5, the conventional cylindrical electric energy storage device 90 includes an electrode winding body 10 for generating charge movement through electrolyte oxidation and reduction, a terminal block 20 electrically connecting the electrode winding body 10 to an external resistor, and a can 30 for fixing the terminal block 20 to the electrode winding body 10 and sealing the electrolyte and the electrode winding body 10 from the exterior.

The electrode winding body 10 has a cylindrical shape in which a positive electrode 16 generating an electron by oxidation reaction, a positive electrode 18 absorbing the generated electron to generate reduction reaction, and separation layers 14 physically separating the negative electrode 16 from the positive electrode 18 and isolating places in which oxidation and reduction occur to divide the electrodes, which are sequentially wound around a winding core 12. From one end of the winding body 10, a plurality of positive electrode leads A formed by a positive electrode collector and a plurality of negative electrode leads formed by a negative electrode collector separately project to form a substantial cylindrical shape.

The terminal block 20 includes positive and negative electrode terminals 24 and 28, positive and negative electrode connection plates 22 and 26 connecting the positive electrode lead A and the negative electrode lead B to the positive and negative electrode terminals 24 and 28, and a coupling member 21 to which the positive and negative electrode terminals and the positive and negative electrode connection plates are fixed. The positive electrode connection plate 22 is in contact with the positive electrode lead A by a positive electrode lead connection part 22a, and the negative electrode connection plate 26 is in contact with the negative electrode lead B by a negative electrode lead connection part 26a.

The positive and negative electrode connection plates 22 and 26 are integrally formed with the body, the lead connection parts 22a and 26a, and the terminals 24 and 28 to form a disc shape. The positive and negative electrode connection plates 22 and 26 may be integrally formed through die-casting, casting, and so on, or the lead connection parts 22a and 26a and the positive and negative electrode terminals 24 and 28 may be connected to the body through any one of welding, soldering, and brazing. A projection 21a is formed at a center of the terminal block 20 to be inserted into the winding core 12 during manufacture of a battery, thereby positioning the connection plates 22 and 26.

The can 30 is formed of a cylindrical structure having one open end, and accommodates the electrode winding body 10. After accommodating the electrode winding body 10, in order to contact the leads A and B formed at an upper end of the electrode winding body 10 with the lead connection parts 22a and 26a, the terminal block 20 is fixed to seal the can 30. At this time, in order to increase sealing effect, a sealing material 29 such as rubber may be used. The can 30 may be formed of a metal material such as aluminum, stainless steel, tin-plated steel, and the like, or a resin material such as PE, PP, PPS, PEEK, PTEE, ESD, and the like. The material for the can 30 may be selected depending on the kind of electrolyte.

After accommodating the electrode winding body 10 in the can 30 and sealing the can 30 using the terminal block 20, the electrolyte is injected into the can 30 through an injection hole H to complete the conventional electric energy storage device 90.

However, as described above, the conventional electric energy storage device 90 has the following problems.

Operation of the electric energy storage device causes active oxidation and reduction in the can, and therefore, gas by-products are generated to increase a pressure in the can 30. The increased pressure generates a space in the can 30 in a vertical direction, and the electrode winding body 10 moved along the space. In particular, when the lead connection parts 22a and 26a are weakly fixed during attachment through welding, soldering, and the like, a gap in the can 30 may be increased in an upward direction to increase movement of the electrode winding body 10. The movement of the electrode winding body 10 causes the leads A and B to be in poor contact with the lead connection parts 22a and 26a, thereby increasing the entire electric resistance.

Meanwhile, when the injection hole H is disposed over the electrode winding body 10, an electrolyte supply time may be increased. FIG. 6 is a view showing a process of charging electrolyte into the conventional electric energy storage device.

As shown in FIG. 6, an injection hose 60 is connected to the injection hole H to pass through the injection hole H to inject electrolyte 61 into the can 30 through the injection hose 60. At this time, since the injection hole H is disposed over a periphery part of the disc-shaped terminal block 20, the electrolyte is supplied to an upper periphery part of the cylindrical electrode winding body 10. At this time, since the interior of the can 30 is formed as a sealed space, when the electrolyte is injected into the sealed space, a gas (for example, air) existing in the can 30 is pushed by the electrolyte 61 to be discharged to the exterior through a discharge hole (not shown) formed in a bottom part B of the can 30.

However, since the electrolyte 61 is supplied from the upper part of the electrode winding body 10, before a center C of the electrode winding body 10 is substantially submerged by the electrolyte 61, the electrolyte 61 flows down through a gap between a sidewall of the can 30 and the electrode winding body 10 to be gathered at the bottom part B of the can 30 such that the discharge hole is clogged by the electrolyte 61. When the electrolyte is continuously injected to completely immerse the center part C of the electrode winding body 10 in the electrolyte, an internal gas existing in the center part C of the electrode winding body 10 is pushed to the bottom part of the can 30, and then, is dissolved in the electrolyte clogging the discharge hole as bubbles to be discharged. Therefore, since the electrolyte should be supplied with the bubbles generated by the internal gas being completely discharged, an electrolyte supply time is lengthened to lower the entire productivity.

### SUMMARY OF THE INVENTION

An object of the present invention is to provide an electric energy storage device capable of suppressing relative movement of an electrode winding body in a can and reducing an electrolyte supply time.

Another object of the present invention is to provide a method of manufacturing the electric energy storage device as described above.

An aspect of the invention provides an electric energy storage device including an electrode winding body, a can, and a terminal block.

The electrode winding body may be configured such that a positive electrode for generating an electron through oxidation and reduction, a negative electrode for absorbing the generated electron, and a separation layer for physically separating the positive electrode from the negative electrode are sequentially wound about a winding core, and may include an electrolyte provided between the positive electrode and the negative electrode. The can may accommodate the electrode winding body, and may include an upper open part, and a bottom part having an injection hole for injecting the electrolyte. The terminal block may be connected to the upper open part of the can to seal the can, and may include an anti-vibration member biased against an inner surface of the winding core to prevent movement relative to the electrode winding body, and positive and negative electrode terminals for electrically connecting the electrode winding body to an external resistor.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a conventional cylindrical electric energy storage device;

FIG. 2 is a plan view of the cylindrical electric energy storage device shown in FIG. 1;

FIG. 3 is a cross-sectional view taken along the line of the cylindrical electric energy storage device shown in FIG. 2;

FIG. 4 is a cross-sectional view taken along the line II-II′ of the cylindrical electric energy storage device shown in FIG. 2;

FIG. 5 is a plan view of an electrode winding body included in the conventional cylindrical electric energy storage device shown in FIG. 1;

FIG. 6 is a cross-sectional view showing a process of charging the conventional electric energy storage device with electrolyte;

FIG. 7 is a perspective view of an electric energy storage device in accordance with an exemplary embodiment of the present invention;

FIGS. 8 and 9 are a plan view and a bottom view of the electric energy storage device shown in

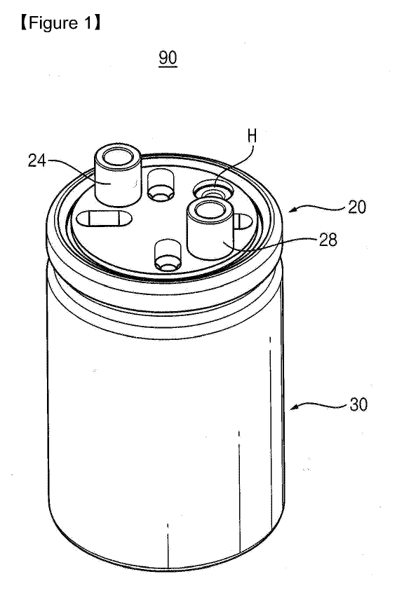

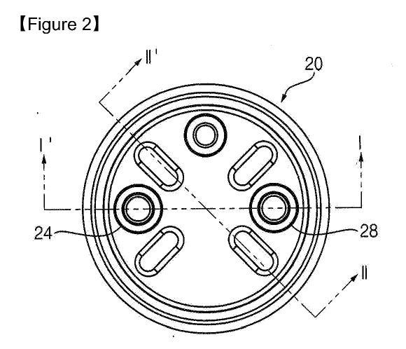

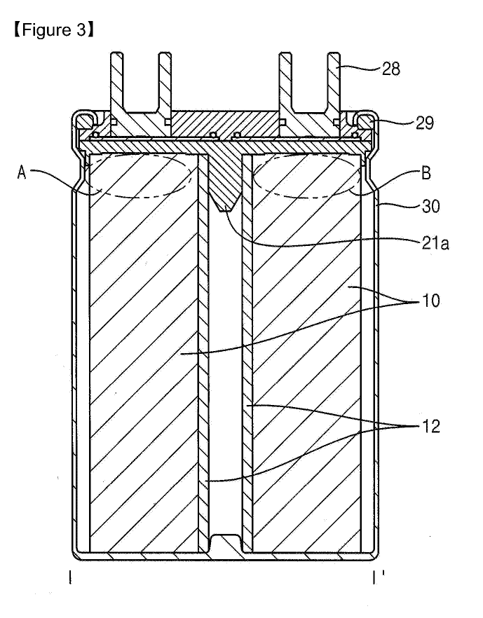

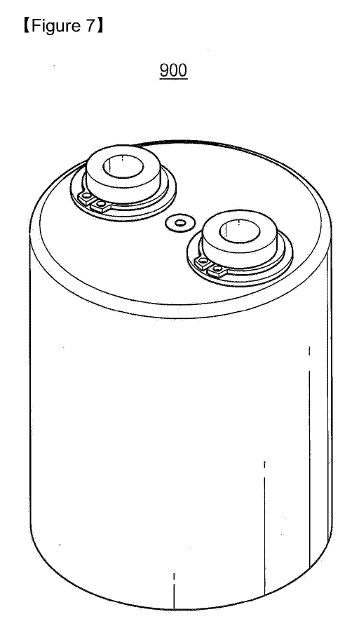

FIG. 7;

FIGS. 10 and 11 are cross-sectional views taken along the lines III-III′ and IV-IV′ of the electric energy storage device shown in FIG. 7;

FIG. 12 is an enlarged cross-sectional view of a bottom plate of the electric energy storage device shown in FIG. 10;

FIG. 13 is an enlarged cross-sectional view of A-part of FIG. 12;

FIG. 14 is a cross-sectional view of a sealing unit shown in FIG. 12;

FIG. 15 is a front perspective view of a terminal block in accordance with an exemplary embodiment of the present invention;

FIG. 16 is a rear perspective view of the terminal block shown in FIG. 15;

FIG. 17 is an exploded perspective view of the terminal block shown in FIG. 15;

FIG. 18 is a perspective view of an anti-vibration member in accordance with an exemplary embodiment of the present invention;

FIG. 19 is a flowchart showing a method of manufacturing an electric energy storage device in accordance with an exemplary embodiment of the present invention;

FIG. 20 is a flowchart showing a terminal block forming step shown in FIG. 19; and

FIG. 21 is a conceptual view showing a method of injecting an electrolyte in accordance with an exemplary embodiment of the present invention.

### DETAILED DESCRIPTION OF EXEMPLARY EMBODIMENTS

Hereinafter, exemplary embodiments of the present invention will be described with reference to the accompanying drawings.

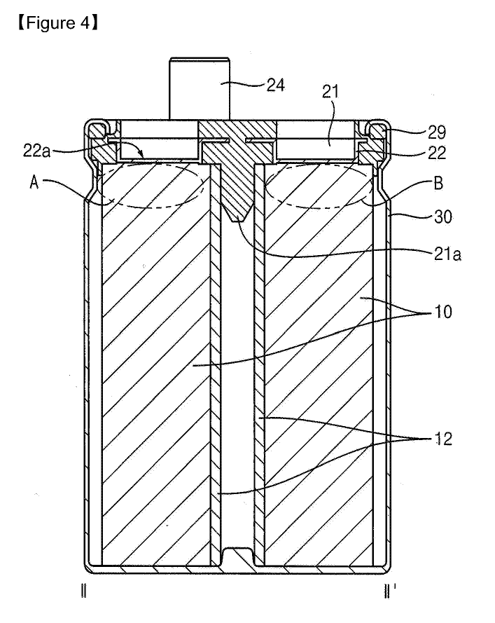

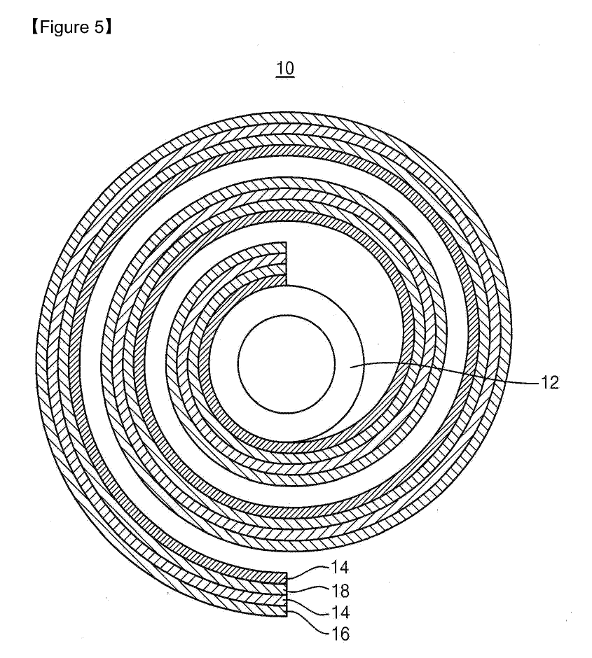

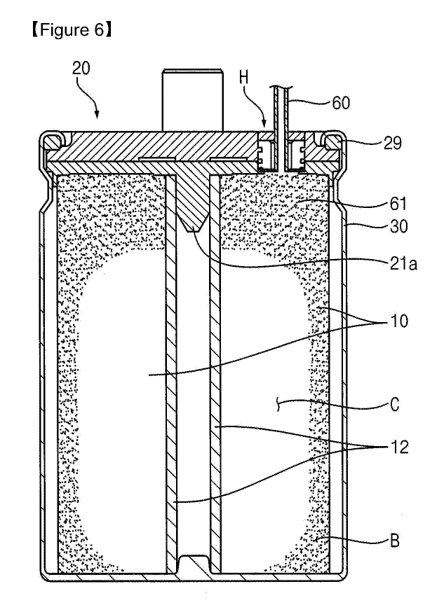

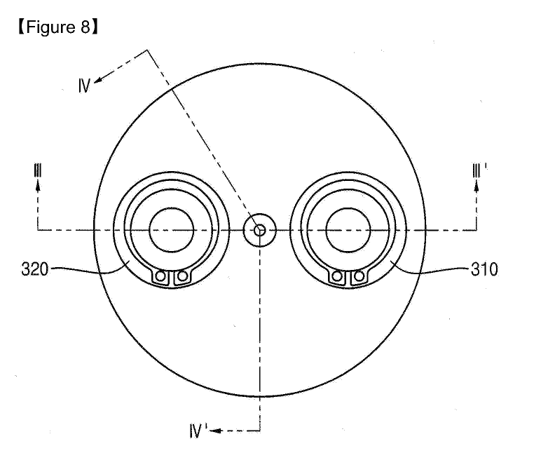

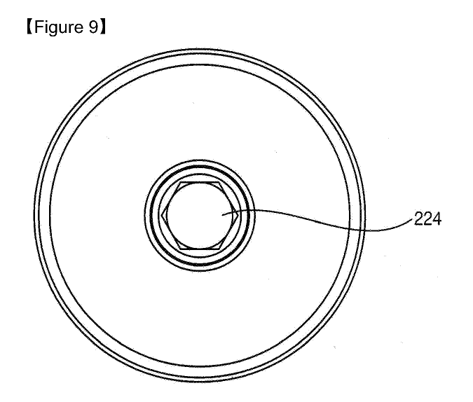

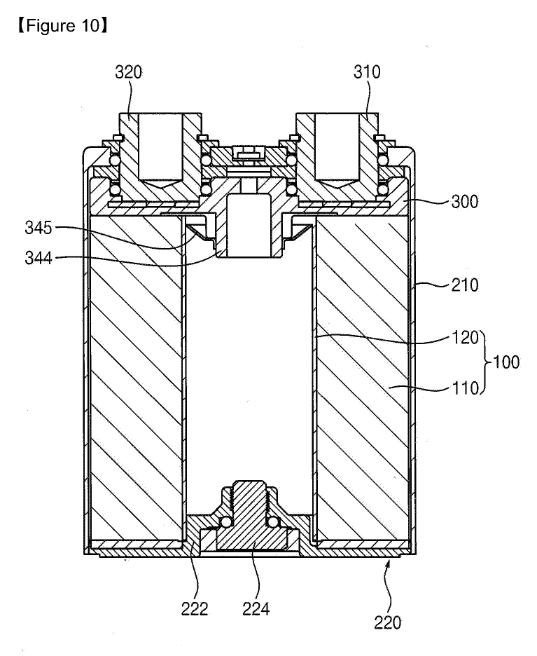

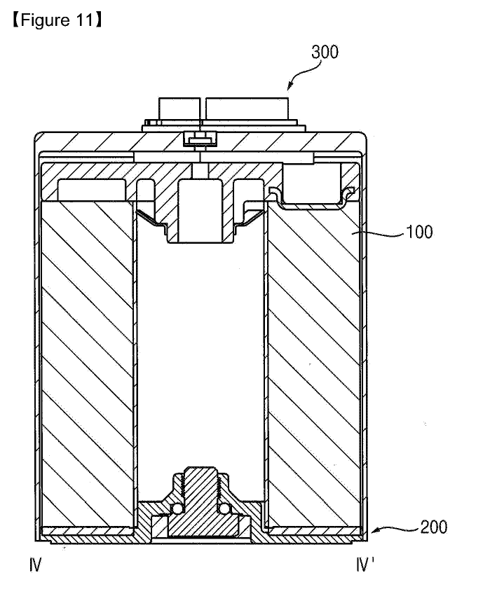

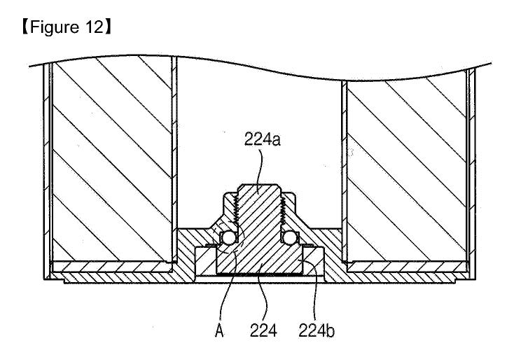

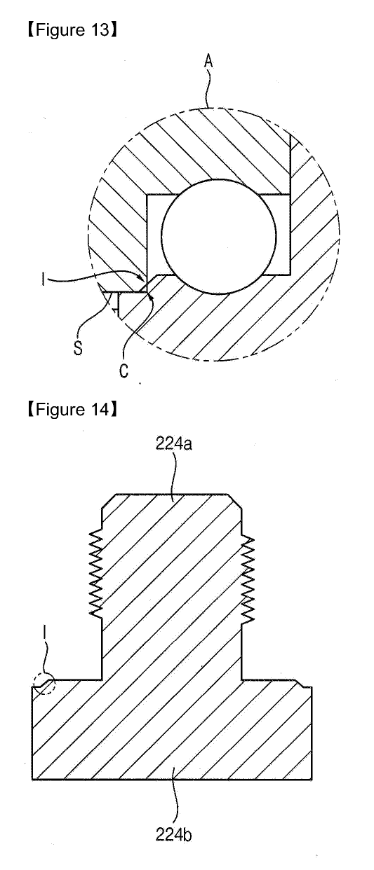

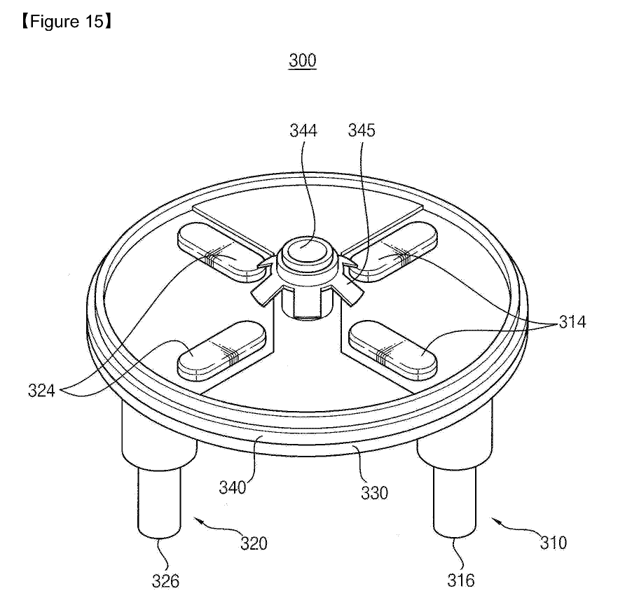

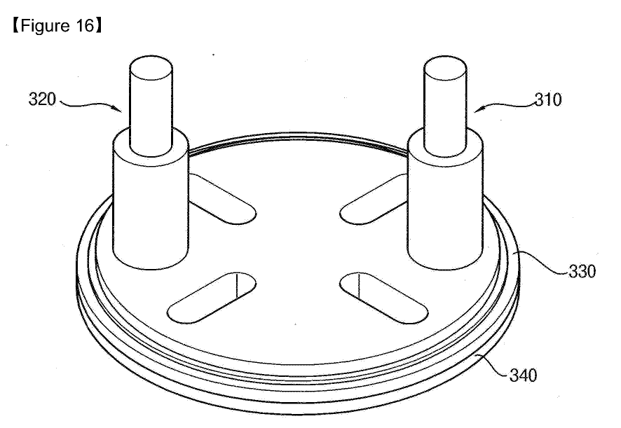

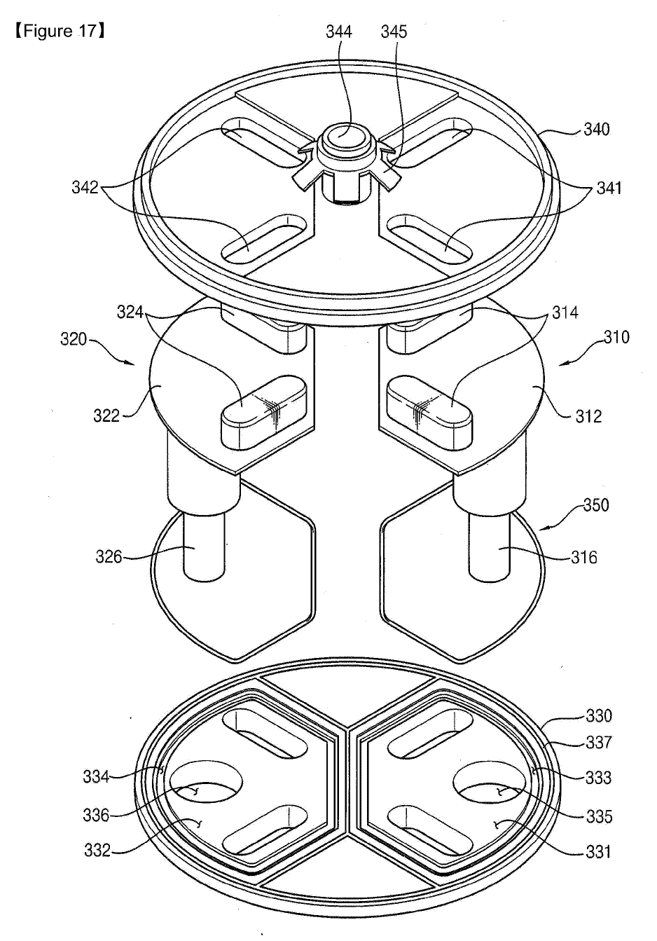

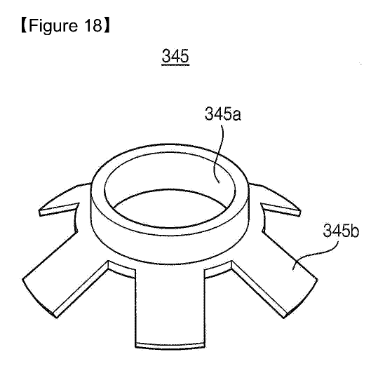

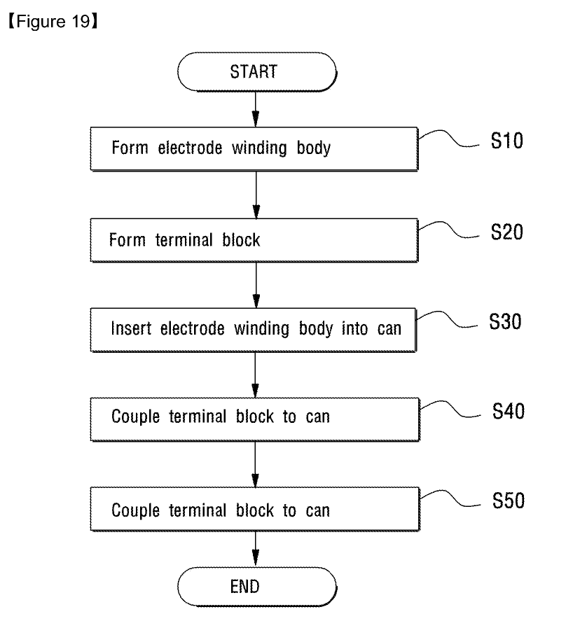

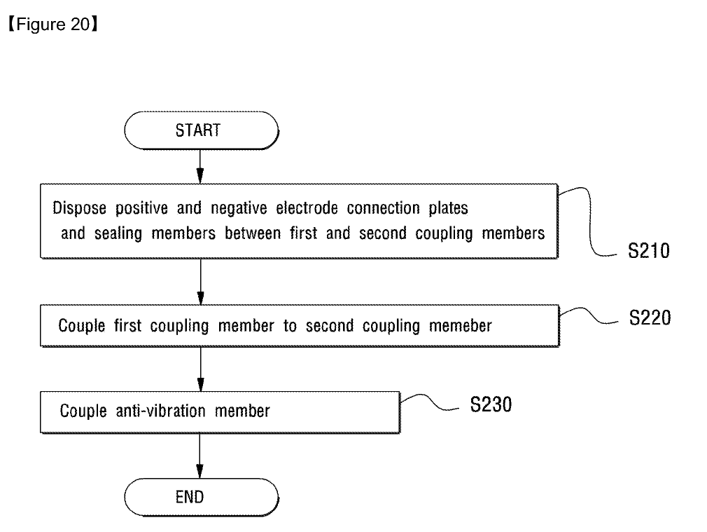

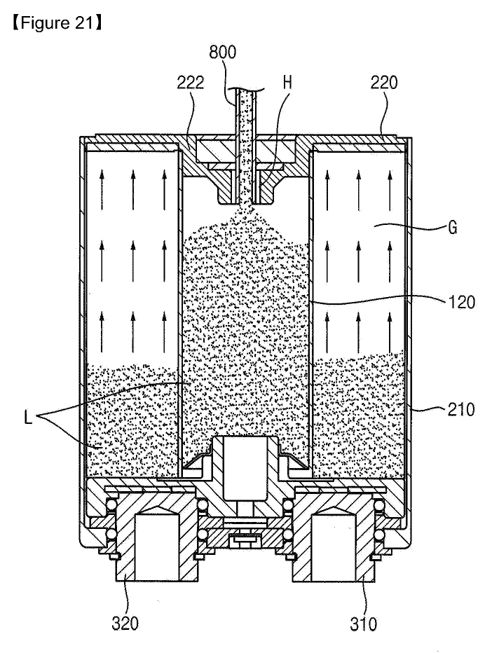

FIG. 7 is a perspective view of an electric energy storage device in accordance with an exemplary embodiment of the present invention, FIGS. 8 and 9 are a plan view and a bottom view of the electric energy storage device shown in FIG. 7, and FIGS. 10 and 11 are cross-sectional views taken along the lines III-III′ and IV-IV′ of the electric energy storage device shown in FIG. 4.

Referring to FIGS. 7, 8, 9, 10 and 11, the electric energy storage device 900 in accordance with an exemplary embodiment of the present invention includes an electrode winding body 100, a can 200 accommodating the electrode winding body 100, and a terminal block 300 electrically connected to the electrode winding body 100 and sealing the can 200.

The electrode winding body 100 generates current through charge movement caused by oxidation and reduction reactions with electrolyte. In this embodiment, the electrode winding body 100 includes a winding unit 110 comprised of a negative electrode (not shown) for generating an electron through oxidation reaction, a positive electrode (not shown) for absorbing the generated electron to generate reduction reaction, and a separation layer, which functions as electrodes, for physically separating the negative electrode from the positive electrode to isolate places in which oxidation and reduction reactions occur to divide the electrodes, and a winding core 120 as a hollow shaft on which the winding unit is wound. Therefore, the electrode winding body has a cylindrical shape in which the winding unit 110 is disposed along the winding core 120. A plurality of positive electrode leads (not shown) formed by the positive electrode collector and a plurality of negative electrode leads formed by the negative electrode collector separately project from one end of the winding unit 110.

Since the winding unit 110 includes the positive electrode leads and the negative electrode leads formed at its one side only, it is possible to more conveniently connect a cable to the terminals in serial or in parallel than in a case where leads are formed at both sides thereof. When the terminals disposed at one side are connected in serial or in parallel, it is possible to readily mount a bus bar after inserting the electric energy storage device in the case. Since the bus bar exists at one side only, it is possible to minimize increase in volume of the case. In addition, when a balancing circuit is used to equal the voltage upon serial connection, it is possible to conveniently use a method of fixing the balancing circuit by screws after positioning the balancing circuit on the bus bar in which the terminals are disposed at one side thereof.

The winding core 120 may be formed of a plastic material or a metal material. In particular, since the metal material has hardness higher than the plastic material, it is possible to readily form an anti-vibration member, which will be described later, at the winding core 120.

In one embodiment, the winding core 120 may be formed as a hollow aluminum shaft to increase resistance against an axial load. When the axial load is applied depending on the internal pressure increased upon operation of the electric energy storage device, it is possible to increase the internal stress against the axial load using the metal material, rather than the plastic material. Therefore, it is possible to suppress generation of a gap between the winding unit 110 and the terminal block 300 or between the winding unit 110 and the can 200 due to increase in the internal pressure caused by operation of the electric energy storage device 900.

The can 200 has a cylindrical shape, an upper part of which is opened to accommodate the electrode winding body 100, and includes a sidewall 210 and a bottom plate 220.

An internal volume of the can 200 is defined by the sidewall 210 and the bottom plate 220, and a second projection 222 projecting into the inner space of the can 200 is formed at a center of the bottom plate 220 to correspond to the winding core 120. The second projection 222 is formed to correspond to the winding core 120. Therefore, when the electrode winding body 100 is inserted into the can 200, the second projection 222 can be inserted into the winding core 120 to accurately guide a position of the electrode winding body 100 in the can 200.

In one embodiment, the sidewall 210 and the bottom plate 220 may be formed of a metal material such as stainless steel, tin-plated steel, and the like, or a resin material such as PE, PP, PPS, PEEK, PTFE, and the like, depending on the kind of electrolyte used therein. For example, when the electric energy storage device 900 using electrolyte is required to have chemical-resistance, PE and PP having good acid-resistance and base-resistance are advantageously used as a material for the can 200, and the stainless steel is partially stable to the electrolyte. When the electric energy storage device 900 uses organic-based electrolytes, the aluminum, which has good cost, chemical resistance, weight and machinability, may be advantageously used as a material for the can, and the PE and PP, which show good chemical-resistance, may be used.

The second projection 222 includes an injection hole H and a sealing unit 224. The electrolyte for promoting charge movement between the positive electrode and the negative electrode is supplied into the can 100 through the injection hole H. At this time, as described below, the gas in the can generated during the injection of the electrolyte may also be effectively discharged through the injection hole H to remarkably reduce an electrolyte supply time. When the injection of the electrolyte is completed, the injection hole H is closed by the sealing unit 224 to isolate the can 200 from the exterior and maintain the sealing of the interior of the can 200.

In one embodiment, the sealing unit 224 includes a bolt threadedly engaged with the injection hole H. FIG. 12 is an enlarged cross-sectional view of a bottom plate of the electric energy storage device shown in FIG. 10, FIG. 13 is an enlarged cross-sectional view of A-part of FIG. 12, and FIG. 14 is a cross-sectional view of a sealing unit shown in FIG. 12.

Referring to FIGS. 12, 13 and 14, the bolt 224 described as one embodiment of the sealing unit 224 includes a tap part 224a and a head part 224b. The head part 224b includes an inclination part I partially formed at a bottom surface thereof and inclined with respect to a threshold surface of the second projection 222. Therefore, the bottom surface of the head part 224b has a two-stage structure divided by the inclination part I.

The inclination part I is fastened to the injection hole H to improve sealing performance of the can 200. When the bolt 224 is threadedly engaged with the injection hole H, as shown in FIG. 13, a corner part C of the bottom plate 220 formed around the injection hole H is in contact with the inclination part I to be pressed along the inclination surface. Therefore, the pressing between the bolt 224 and the bottom plate 220 strengthens the sealing of the can to substantially prevent leak of the electrolyte through the injection hole H. Preferably, an O-ring may be disposed at a lower end of the head part 224b to strengthen a fastening force of the bolt 224 and improve sealing performance of the can.

FIG. 15 is a front perspective view of a terminal block in accordance with an exemplary embodiment of the present invention, FIG. 16 is a rear perspective view of the terminal block shown in FIG. 15, and FIG. 17 is an exploded perspective view of the terminal block shown in FIG. 15.

Referring to FIGS. 9 to 11, the terminal block 300 includes a positive electrode connection plate 310, a negative electrode connection plate 320, a first coupling member 330, a second coupling member 340, and sealing members 350.

The positive electrode connection plate 310 includes a positive electrode connection plate body 312, positive electrode lead connection parts 314, and a positive electrode terminal 316. The positive electrode connection plate body 312 is formed of a fan-shaped plate. The positive electrode lead connection parts 314 project from an upper surface of the positive electrode connection plate body 312.

The positive electrode lead connection parts 314 are adhered to the positive electrode lead extending from the positive electrode. The positive electrode terminal 316 projects from a lower surface of the positive electrode connection plate body 312. In the positive electrode connection plate 310, the positive electrode connection plate body 312, the positive electrode lead connection parts 314, and the positive electrode terminal 316 are integrally formed with each other. The positive electrode connection plate 310 may be integrally formed through die-casting, casting, and so on, or the positive electrode lead connection parts 314 and the positive electrode terminal 316 may be attached to the positive electrode connection plate body 312 through any one of welding, soldering, and brazing.

The negative electrode connection plate 320 has a shape symmetrical to the positive electrode connection plate 310. The negative electrode connection plate 320 includes a negative electrode connection plate body 322, negative electrode connection parts 324, and a negative electrode terminal 326. The negative connection plate body 322 is formed of a substantial fan-shaped plate. The negative electrode lead connection parts 324 project from an upper surface of the negative electrode connection plate body 322. The negative electrode lead connection parts 324 are adhered to the negative electrode lead projecting from the negative electrode. The negative electrode terminal 326 projects from a lower surface of the negative electrode connection plate body 322. In the negative electrode connection plate 320, the negative electrode connection plate body 322, the negative electrode lead connection parts 324, and the negative electrode terminal 326 are integrally formed with each other. The negative electrode connection plate 320 may be integrally formed through die-casting, casting, and so on, or the negative electrode lead connection parts 324 and the negative electrode terminal 326 may be attached to the negative electrode connection plate body 322 through any one of welding, soldering, and brazing.

The positive electrode connection plate 310 and the negative electrode connection plate 320 may be formed of a metal material. Specifically, the positive electrode lead connection parts 314 may be formed of the same material as the positive electrode, and the negative electrode lead connection parts 324 may be formed of the same material as the negative electrode. Since the positive electrode terminal 316 and the negative electrode terminal 326 are not exposed to the electrolyte, the material should be selected in consideration of mechanical and electrical characteristics, rather than electrochemical stability. Therefore, a material that can be readily attached through welding, soldering, brazing, and the like, may be used. In one embodiment, copper alloy or aluminum alloy having good mechanical characteristics and electrical conductivity may be used as the terminal 316 and 326.

The first coupling member 330 is formed as a disc-shape, and has a first groove 331 formed at an upper surface thereof and accommodating the positive electrode connection plate body 312, and a second groove 332 formed at the upper surface and accommodating the negative electrode connection plate body 322. The first groove 331 is formed to correspond to the positive electrode connection plate body 312, and the second groove 332 is formed to correspond to the negative electrode connection plate body 322. A third groove 333 is formed along the periphery of the first groove 331. Similarly, a fourth groove 334 is formed along the periphery of the second groove 332.

A first accommodating hole 335 is formed at a center part of the first groove 331 to vertically pass through the first coupling member 330 and accommodate the positive electrode terminal 316 of the positive electrode connection plate 310. A second accommodating hole 336 is formed at a center part of the second groove 332 to vertically pass through the first coupling member 330 and accommodate the negative electrode terminal 326 of the negative electrode connection plate 320. A rim 337 is formed along a periphery of the upper surface of the first coupling member 330. The rim 337 is used to couple the first coupling member 330 to the second coupling member 340.

Meanwhile, a first hole 338 is formed at one side of the first coupling member 330 to vertically pass therethrough. The first hole 338 has a thread formed at its inner surface to fix a safety piece. The safety piece is broken at a pressure lower than an explosion pressure of the energy storage device 900 in order to prevent the energy storage device 900 from being exploded due to a high pressure.

The second coupling member 340 is formed of a disc-shaped plate, and has third accommodating holes 341 formed at one side thereof, vertically passing through the second coupling member 340, and accommodating the positive electrode lead connection parts 314 of the positive electrode connection plate 310. Fourth accommodating holes 342 are formed at the other side of the second coupling member 340 to vertically pass through the second coupling member 340 and accommodate the negative electrode lead connection parts 324 of the negative electrode connection plate 320. Meanwhile, a second hole 343 is formed at the second coupling member 340 to correspond to the first hole 338 of the first coupling member 330. Similar to the first hole 338, the second hole 343 has a thread formed at its inner surface to fix a safety piece.

A first projection 344 is formed at a center of an upper surface of the second coupling member 340. Similar to the second projection 222, the first projection 344 is inserted into the winding core 120 of the electrode winding body 100. Therefore, the first projection 344 enables the positive electrode lead and the negative electrode lead disposed on the winding unit to be accurately adhered to the positive electrode lead connection parts 314 and the negative electrode lead connection parts 324, respectively.

The first coupling member 330 is integrally formed with the second coupling member 340. In order to integrally form the first coupling member 330 with the second coupling member 340, ultrasonic welding is performed at the rim 337 of the first coupling member 330.

Meanwhile, an anti-vibration member 345 having resilience is disposed at an end of the first projection 344. FIG. 18 is a perspective view of an anti-vibration member in accordance with an exemplary embodiment of the present invention.

Referring to FIG. 18, the anti-vibration member 345 in accordance with an exemplary embodiment of the present invention includes a threaded fastener. The threaded fastener includes a body part 345a having a thread formed at its inner surface and threadedly coupled to the first projection 344, and a blade part 345b projecting over the winding core 120 in a radial direction of the body part 345a in an inclined manner. A region of the winding core 120 adjacent to the terminal block 300 is defined as an upper part of the winding core 120, and a region of the winding core 120 adjacent to the bottom plate 220 is defined as a lower part of the winding core 120. The fastener is formed of a material having good fatigue characteristics due to repeated loads, and the blade part 345b is formed of good resilience characteristics.

Since the fastener as the anti-vibration member 345 has the blade part 345b formed toward the upper part of the winding core 120 in an inclined manner, the first projection 344 can be readily inserted into the winding core 120 by an axial load applied downward from the winding core 120. However, once the first projection 344 is inserted, since a strong friction force is applied between the blade part 345b and the inner surface of the winding core 120 by a resilient force of the blade part 345b, it is impossible to readily separate the first projection 344 from the winding core 120 even when an axial load is applied in an upward direction of the winding core.

Therefore, even though the axial load or external vibration is applied to the terminal block 300 and the bottom plate 220 of the can 200 by an internal pressure increased due to driving of the electric energy storage device 900, it is possible to substantially maintain the contact between the electrode winding body 100 and the terminal block 300. Therefore, it is possible to minimize increase in electric resistance of a welding part by suppressing relative movement between the terminal block 300 and the electrode winding body 100.

The sealing members 350 are installed between the positive electrode connection plate 310 and the first coupling member 330 and between the negative electrode connection plate 320 and the first coupling member 330. Specifically, the sealing members 350 are installed at the third groove 333 and the fourth groove 334. Therefore, the sealing members 350 have a closed loop shape. The sealing members 350 may be formed of a rubber material. The sealing members 350 can prevent the electrolyte from being leaked through between the positive electrode connection plate 310 and the first coupling member 330 and between the negative electrode connection plate 320 and the first coupling member 330.

In accordance with the electric energy storage device of the present invention, separation of the welding part between the electrode winding body and the terminal block due to increase in the internal pressure and external vibration caused by the drive of the electric energy storage device can be prevented by forming the anti-vibration member as a resilient body at the projection of the terminal block inserted into the winding core and pressing the anti-vibration member to the inner surface of the winding core.

Hereinafter, a method of manufacturing an electric energy storage device in accordance with an exemplary embodiment of the present invention will be described.

FIG. 19 is a flowchart showing a method of manufacturing an electric energy storage device in accordance with an exemplary embodiment of the present invention, and FIG. 50 is a flowchart showing a terminal block forming step shown in FIG. 19.

Referring to FIGS. 7 to 20, a positive electrode having a positive electrode lead, a separation layer, and a negative electrode having a negative electrode lead are sequentially wound to form an electrode winding body 100 (S10). The electrode winding body 100 is wound in a cylindrical shape about a winding core 120 such that the separation layer is disposed between the positive electrode and the negative electrode. At this time, portions of the positive electrode and the negative electrode are pre-formed and then wound such that the positive electrode lead and the negative electrode lead separately extend at one side of the electrode winding body 100.

A terminal block 300 is separately manufactured from the electrode winding body 100 (S20). In one embodiment, a positive electrode connection plate 310, a negative electrode connection plate 320, and sealing members 350 are disposed between a first coupling member 330 and a second coupling member 340 (S210).

Specifically, the sealing members 350 are inserted between a third groove 333 and a fourth groove 334 formed at an upper surface of the first coupling member 330. Next, a body 312 of the positive electrode connection plate 310 is inserted into a first groove 331 of the first coupling member 330. At this time, a positive electrode terminal 316 is accommodated in a first accommodating hole 335 of the first coupling member 330 to project under the first coupling member 330. Similarly, a body 322 of the negative electrode plate 320 is inserted into a second groove 332 of the first coupling member 330. At this time, a negative electrode terminal 326 is accommodated in a second accommodating hole 336 of the first coupling member 330 to project under the first coupling member 330. Then, the second coupling member 340 is inserted onto the first coupling member 330 to surround the positive electrode connection plate 310 and the negative electrode connection plate 320. At this time, positive electrode lead connection parts 314 of the positive electrode connection plate 310 is accommodated in third accommodating holes 341 of the second coupling member 340 to project over the second coupling member 340. Similarly, negative electrode lead connection parts 324 of the negative electrode connection plate 320 is inserted into fourth accommodating holes 342 of the second coupling member 340 to project over the second coupling member 340.

When the first coupling member 330, the second coupling member 340, the positive electrode connection plate 310, the negative electrode connection plate 320, and the sealing member 350 are disposed as described above, the first coupling member 330 is coupled to the second coupling member 340 (S220). Ultrasonic waves are applied to a rim 337 formed along a periphery of the upper surface of the first coupling member 330 to melt the rim 337. The rim 337 is melted to integrate the first coupling member 330 with the second coupling member 340. That is, the first coupling member 330 is coupled to the second coupling member 340 by the melting.

Then, an anti-vibration member 345 is coupled to an end of the first projection 344 (S230). In one embodiment, a threaded fastener is threadedly engaged with the end of the first projection 344.

The electrode winding body 100 is inserted into a can 200 (S30).

The electrode winding body 10 is inserted into the can 200 through an opening thereof such that the winding core 120 is fixed to the second projection 222 formed at a center of a bottom plate 220 of the can 200. At this time, the positive electrode lead and the negative electrode lead of the electrode winding body 100 are directed to the opening of the can 200.

The terminal block 300 is coupled to the can 200, into which the electrode winding body 100 is inserted (S40).

The terminal block 300 is fixed to the can 200 such that the positive electrode lead connection part and the negative electrode lead connection part of the terminal block 300 are adhered to the positive electrode lead and the negative electrode lead. The first projection 344 formed at a center of the terminal block 300 fixes the winding core 120 of the electrode winding body 100 together with the second projection 222 such that the positive electrode lead and the negative electrode lead of the electrode winding body 100 are continuously adhered to the positive electrode lead connection part and the negative electrode lead connection part of the terminal block 200. The terminal block 300 may be coupled to the can 200 through various methods such as welding, seaming, and so on. Of course, it is possible to increase sealing performance of the can 200 by interposing a sealing means such as a rubber ring between the terminal block 300 and the can 200 in a state such that the terminal block 300 is fixed to the can 200.

A blade part 345b of the anti-vibration member 345 is strongly pressed against an inner surface of the winding core 120 to fix a position of the winding unit 110. Therefore, while external vibrations are applied, it is possible to prevent the terminal block from being in poor contact with the winding unit by using a strong friction force formed between the blade part and the inner surface of the winding core.

An electrolyte is injected into the can through the bottom plate (S50). FIG. 51 is a conceptual view showing a method of injecting an electrolyte in accordance with an exemplary embodiment of the present invention.

Referring to FIG. 21, an injection hose 800 is inserted into an injection hole H formed at the second projection 222 to inject the electrolyte L into the can 200. Since the electrolyte is supplied with the can being upside down such that the bottom plate is directed upward, the electrolyte, which to be supplied, is filled from an interface between the winding unit and the terminal block. At this time, an internal gas including air existing in the can is pushed toward the bottom plate by the electrolyte, and the pushed internal gas is readily discharged to the exterior through a gap between the injection hole H and the injection hose 800. Therefore, since it is possible to prevent the discharge hole for an internal gas from being clogged due to the electrolyte, it is possible to remarkably reduce an electrolyte supply time.

When the injection of the electrolyte is completed, the injection hole H is sealed using a bolt to securely seal the interior of the can. At this time, as described above, the bottom surface of the head part of the bolt is formed as a two-stage structure to more improve sealing performance thereof.

While not shown, a safety piece is installed at a hole formed at one side of the terminal block 300 to vertically pass therethrough. The safety piece includes a hole formed in a longitudinal direction thereof and having a thread formed at its outer surface to correspond to a thread formed at an inner surface of the hole. A metal thin layer is mounted in the hole formed in the longitudinal direction to block the hole. The metal thin layer is broken at a pressure lower than an explosion pressure such that the safety piece functions to prevent the electric energy storage device 300 from being exploded due to a high pressure.

In accordance with the method of manufacturing an electric energy storage device of the present invention, the electrolyte is injected through the bottom plate such that the electrolyte is filled from the interface between the winding unit and the terminal block to the bottom plate. Therefore, the internal gas existing in the can is smoothly discharged to the exterior through the injection hole to enable the electrolyte supply time to be substantially reduced.

As can be seen from the foregoing, in accordance with an electric energy storage device and a method of manufacturing the same according to an exemplary embodiment of the present invention, separation of the welding part between the electrode winding body and the terminal block due to increase in the internal pressure and external vibration caused by the drive of the electric energy storage device can be prevented by forming the anti-vibration member as a resilient body at the projection of the terminal block inserted into the winding core and pressing the anti-vibration member to the inner surface of the winding core. Therefore, it is possible to increase electric safety of the electric energy storage device.

In addition, the electrolyte is injected through the bottom plate to smoothly discharge the internal gas in the can, thereby reducing an electrolyte injection time.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. An electric energy storage device comprising:
a terminal block for external connection connected to an external electrode connection member such as an external resistor;
a cylindrical can for accommodating an electrode winding body;
an electrolyte impregnated in the electrode winding body; and
an anti-vibration member fixed to an outer periphery of a first projection of the terminal block, and resiliently pressed against an inner surface of one end of a winding core inserted into a hollow part of the electrode winding body to prevent movement of the electrode winding body with respect to the terminal block.

2. The electric energy storage device according to claim 1, wherein the winding core has a cylindrical shape.

3. The electric energy storage device according to claim 1, wherein the anti-vibration member includes a threaded fastener threadedly engaged with the first projection.

4. The electric energy storage device according to claim 1, wherein the anti-vibration member includes a body part threadedly coupled to the first projection, and a blade part formed of a plate-shaped resilient body radially extending from the body part toward an upper part of the winding core at a specific angle.

5. The electric energy storage device according to claim 1, wherein the can accommodates the electrode winding body, and includes an open upper end and a bottom part having an injection hole for injecting the electrolyte, and
the can comprises a bottom plate having a second projection projecting from the can into the winding core and a sealing unit for maintaining sealing performance in the can, wherein the injection hole is in communication with the interior of the winding core through the second projection.

6. The electric energy storage device according to claim 5, wherein the sealing unit comprises a bolt threadedly engaged with the injection hole.

7. The electric energy storage device according to claim 6, wherein the bolt comprises a tap part having a thread formed at its surface to be threadedly engaged with the injection hole, and a head part integrally formed with the tap part and having an inclined surface inclined with respect to the surface of the bottom plate at a specific angle, and when the bolt is fastened thereto, a corner of the bottom plate in contact with the head part is pressed in an inclined manner along an inclined direction of the inclined surface.

8. The electric energy storage device according to claim 1, wherein the terminal block comprises a positive electrode connection plate having a positive electrode connection part electrically connected to the positive electrode and a positive electrode terminal opposite to the positive electrode connection part, a negative electrode connection plate having a negative electrode connection part electrically connected to the negative electrode and a negative electrode terminal opposite to the negative electrode connection part, a coupling member surrounding the positive electrode connection plate and the negative electrode connection plate to expose the positive and negative electrode connection parts and the terminals and insulating the positive electrode connection plate from the negative electrode connection plate, and a second projection projecting from a surface of the coupling member to be inserted into the winding core.
